(19) United States
(12) Patent Application Publication
(10) Pub. No.: US 2004/0042136 A1
(43) Pub. Date: Mar. 4, 2004

(54) Motor control device having temperature protection function

(76) Inventor: Kuei Wei Kuo, Hsin Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/233,538

(22) Filed: Sep. 4, 2002

(51) Int. Cl. H02H 5/04

(52) U.S. Cl. 361/25

(57) ABSTRACT

A motor control device having temperature protection function comprises a motor drive module and a temperature detection and control module. The motor drive module comprises a driver, a magnetic field detector, and a voltage regulator. The driver is used to drive a motor. The magnetic field detector is used to detect a magnetic field variation signal of the motor. The temperature detection and control module comprises a temperature sensor and a hysteresis switch, and is used to detect the temperature of the motor for controlling disconnection and restart of the motor according to the temperature value. The voltage regulator is connected to an external power source, and is used to provide a stable voltage to the whole motor control device. Thereby, the advantages of simple design, low cost, and prevention of over heat of motor can be achieved.

### FIELD OF THE INVENTION

The present invention relates to a motor control device and, more particularly, to a motor control device having temperature protection function.

### BACKGROUND OF THE INVENTION

Along with progress of science and technology, high power operation of delicate electronic products is increasingly desirable. However, high power electronic products will easily generate a great deal of heat in use. In addition to causing doubt of safety in use, components of the products will also be easily damaged to stop functioning. Therefore, most electronic products have cooling fans in design to achieve heat-radiating effect when the products are used. In the design of cooling fan, appropriate selection of motor control products not only can greatly enhance the function of fan, but also can ensure heat-radiating effect of the product or equipment.

Recently, due to enhancement of operational speed of microcomputers and maturity of semiconductor techniques, the design of motor drive and control products has been much improved. In the motor control products, in order to prevent the rotor of the motor from being locked due to an external factor so as to be unable to operate normally and thus cause the situation of over heat and burnout when the motor operates, a lockup disconnection protection circuit is generally designed in the motor control product to automatically disconnect the electricity and stop the operation of the motor. Therefore, when the rotation of the rotor of the motor is limited, the electricity is automatically disconnected to stop the operation of the motor, hence avoiding continual rise of the temperature of the motor. However, many electronic components and a complicated control circuit are required in the design of the lockup disconnection protection circuit, hence having the drawbacks of difficult manufacturing and high cost.

Accordingly, the present invention aims to propose a motor control device having temperature protection function without the design of a lockup disconnection protection circuit.

### SUMMARY AND OBJECTS OF THE PRESENT INVENTION

The primary object of the present invention is to provide a motor control device having temperature protection function, wherein a temperature detection and control module is designed to disconnect a motor when the temperature of the motor is too high and restart the motor when the temperature of the motor drops to be within a safe range, thereby achieving the disconnection and protection effect.

Another object of the present invention is to provide a motor control device having a simple design and a low cost.

According to the present invention, a motor control device having temperature protection function comprises a motor drive module, which comprises a driver, a magnetic field detector, and a voltage regulator. The driver is used to drive a motor. The magnetic field detector is used to detect a magnetic field variation signal of the motor. A temperature detection and control module is connected with the motor drive module to detect the temperature of the motor so as to control disconnection and restart of the motor according to the temperature value. The voltage regulator is connected to an external power source, and is also connected to the driver, the magnetic field detector, and the temperature detection and control module. The voltage regulator is used to provide a stable voltage to the whole motor control device.

The various objects and advantages of the present invention will be more readily understood from the following detailed description when read in conjunction with the appended drawings, in which:

### BRIEF DESCRIPTION OF DRAWINGS

FIG. 1 is a structure block diagram of the present invention; and

FIG. 2 is a structure block diagram of a magnetic field detector of the present invention.

### DETAILED DESCRIPTION OF PREFERRED EMBODIMENT

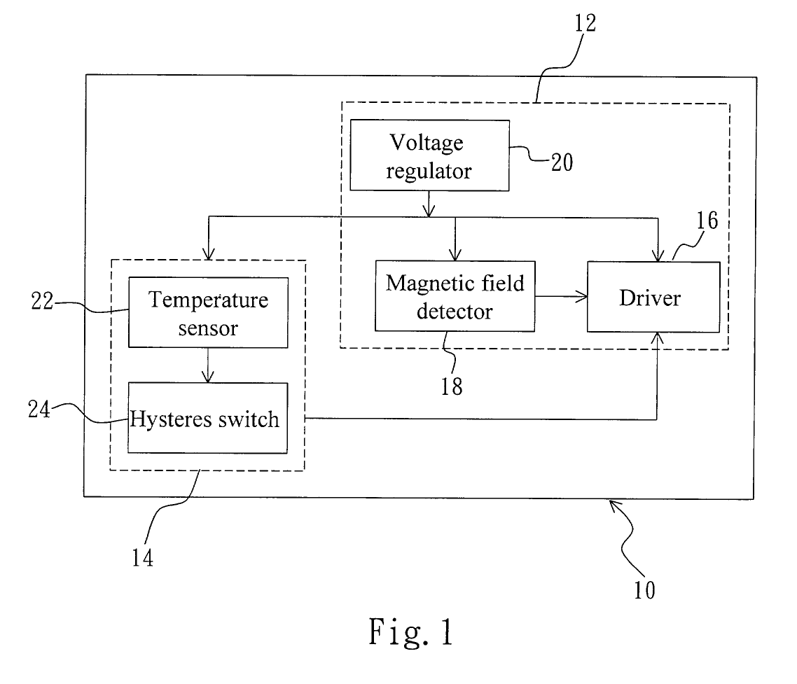

As shown in FIG. 1, a motor control device 10 comprises a motor drive module 12 and a temperature detection and control module 14. The motor drive module 12 comprises a driver 16, a magnetic field detector 18, and a voltage regulator 20. The driver 16 is connected with a switch circuit (no shown), and is connected to a motor coil set via the switch circuit. The magnetic field detector 18 is connected to the driver 16, and is used to detect a magnetic field variation signal of a motor and then output this signal to the driver 16. The voltage regulator 20 is connected with the driver 16, the magnetic field detector 18, and the temperature detection and control module 14, and is used to provide a stable voltage to the whole motor control device 10. The temperature detection and control module 14 comprises a temperature sensor 22 and a hysteresis switch 24, and is used to detect the temperature of the motor to control disconnection and restart of the motor according to the temperature value.

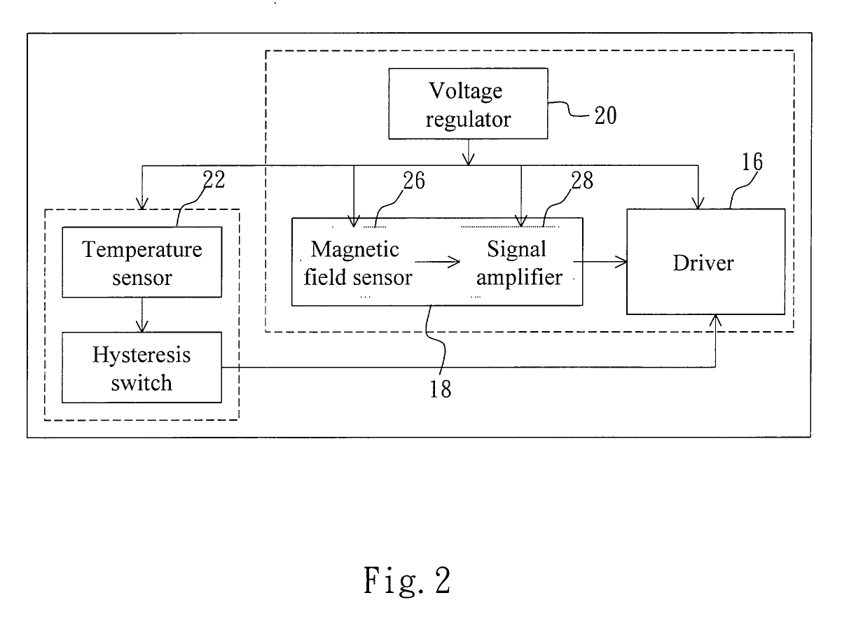

As shown in FIG. 2, the magnetic field detector 18 comprises a magnetic field sensor 26 and a signal amplifier 28, and is used to amplify a motor's magnetic field switching signal sensed by the magnetic field sensor 26 by using the signal amplifier 28 and then output to the driver 16.

In the present invention, when the motor operates normally, its temperature is kept within a normal range. When the rotor of the motor is locked by an external force and can no longer rotate, the temperature of the motor will rise. When the temperature continually rises to a disconnection temperature value set by the hysteresis switch 24, the hysteresis switch 24 will send out a disconnection signal to let the motor drive module 12 cut off the originally on switch circuit according to the disconnection signal so that there will be no current on the motor coil set, thereby stopping operation of the motor to achieve the disconnection and protection effect. When the motor stops operation to let the temperature of the motor drop to a restart temperature value, the hysteresis switch 24 will send out a restart signal to restart the motor. The above actions are repeated until the limit of the external force to the rotor of the motor is removed.

In the present invention, the design of the temperature detection and control module 14 disconnects the motor when the motor is locked by an external force or other factors to cause too high temperature of the motor, and restarts the motor when the temperature of the motor drops to be within a safe range, thereby preventing the motor from burnout due to too hot to provide protection function. On the other hand, the present invention can provide a motor control device having temperature protection function of simple design and low cost as compared to the prior art.

Although the present invention has been described with reference to the preferred embodiments thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A motor control device having temperature protection function, comprising:
a motor drive module used to drive a motor to rotate; and
a temperature detection and control module connected with said motor drive motor to detect the temperature of said motor and control disconnection and restart of said motor according to the temperature value.

2. The motor control device as claimed in claim 1, wherein said motor drive module comprises:
a driver used to drive said motor;
a magnetic field detector connected with said driver and used to detect a magnetic field variation signal of said motor; and
a voltage regulator connected to a power source and also connected to said temperature detection and control module, said driver, and said magnetic field detector.

3. The motor control device as claimed in claim 2, wherein said magnetic field detector comprises a magnetic field sensor and a signal amplifier.

4. The motor control device as claimed in claim 1, wherein said temperature detection and control module comprises a temperature sensor and a hysteresis switch.
